(19) United States
(12) Patent Application Publication
(10) Pub. No.: US 2004/0143436 A1
(43) Pub. Date: Jul. 22, 2004

(54) Apparatus and method of processing natural language speech data

(76) Inventors: Liang-Sheng Huang, Taipei (TW); Jia-Lin Shen, Taipei (JP)

Correspondence Address: BIRCH STEWART KOLASCH & BIRCH, PO BOX 747, FALLS CHURCH, VA, 22040-0747, US

(21) Appl. No.: 10/739,150

(22) Filed: Dec. 19, 2003

(30) Foreign Application Priority Data
Jan. 20, 2003 (TW) 92101098

(51) Int. Cl. G10L 15/18

(52) U.S. Cl. 704/257

(57) ABSTRACT

An apparatus for processing natural language speech data. The inventive apparatus includes an automatic speech recognition unit, a natural language understanding unit, and an action and response unit. The three units are installed in a handheld communication device. The automatic speech recognition unit extracts and recognizes features of the natural language input to produce an automatic speech recognition result. The natural language understanding unit receives, understands, and analyzes the automatic speech recognition result to produce a natural language understanding result. The action and response unit receives and processes the natural language understanding result to produce an output response.

### BACKGROUND OF THE INVENTION

1. Field of the Invention

The present invention relates to speech data processing technology and in particular to an apparatus and method of processing natural language speech data.

2. Description of the Related Art

With the progress of communication technology, use of handheld communication devices has become increasingly popular. Currently there are two main developing trends in handheld communication device technology. The first is the reduction in size of handheld communication devices. The second is the powerful capability of combined computing and communication. Integration of various computing and communication functions in a single handheld device is inevitable. Thus, utilizing speech to control the handheld device will become important.

Currently, speech-control in handheld communication devices is limited to major functions. That is, devices are currently capable of recognizing pre-determined speech commands to perform a few major functions, such as dialing a number or sending messages. The speech data recognition process of the mentioned handheld device mainly limited to pre-processing of the input speech data, extracting, based on stored speech templates, to obtain the final result.

As mentioned above, the current recognition technology is not capable of semantic understanding. If the input speech commands are not certain pre-determined, stored commands, the current recognition technology is not capable of producing a result. Generally speaking, however, users are not accustomed to speaking in commands, but rather, in natural language. Additionally, recent handheld devices provide more complex features. These complex features cannot be controlled completely by the limited range of commands supported by current handheld devices complicating attempts to design a responsive user interface. Hence, development of handheld communication devices with natural language speech data processing capability is the prevailing design trend.

The related technology is shown in “JUPITER: A Telephone-Based Conversation Interface for Weather Information,” IEEE Trans. Speech and Audio Proc, 8(1), 85-96, 2000, and the U.S. patent No. 005749072, “Communications device responsive to spoken commands and methods of using same.”

### SUMMARY OF THE INVENTION

Accordingly, an object of the invention is to provide a handheld communication device with natural language speech data processing capability. Natural language speech data is input to control the various features of the handheld communication device. The handheld communication device analyzes the input speech and executes the corresponding task.

Another object of the invention is to integrate natural language data processing capability into a single handheld communication device. In other words, the speech data can be input, recognized, and executed by a single handheld communication device. The inventive handheld device improves on current technology by directly processing input speech in the device. Currently, speech data input to a handheld communication device with speech understanding capabilities is transmitted to a remote server for speech recognition, the recognition result is then returned to the device, causing wasted bandwidth. The inventive handheld communication device prevents wasted bandwidth by processing speech data in the handheld communication device directly.

To achieve the foregoing objects, the invention provides an apparatus for processing natural language speech data input received by a handheld communication device. The speech input is then processed to produce an output response. The inventive apparatus comprises an automatic speech recognition unit, a natural language understanding unit, and an action and response unit installed in the handheld communication device. The automatic speech recognition unit receives the natural language speech input, extracts and recognizes features of the natural language speech input, and produces an automatic speech recognition result. The natural language understanding unit receives the automatic speech recognition result. The natural language understanding unit then analyzes the automatic speech recognition result to produce a natural language understanding result. The action and response unit receives and processes the natural language understanding result producing the output response.

### BRIEF DESCRIPTION OF THE DRAWINGS

The present invention can be more fully understood by reading the subsequent detailed description and examples with references made to the accompanying drawings, wherein:

FIG. 1 is a diagram of the handheld communication device and the network according to the present invention.

FIG. 2 is a diagram of the handheld communication device according to the present invention.

FIG. 3 is a diagram of an apparatus of processing natural language speech data according to the present invention.

FIG. 4 is a flowchart of the method of processing natural language speech data according to the present invention.

FIG. 5 is a diagram illustrating the grammar of the present invention according to one embodiment.

FIG. 6 is a diagram illustrating the parsing tree of the present invention according to one embodiment.

FIG. 7 is a diagram illustrating the semantic frames of the present invention according to one embodiment.

FIG. 8 is a diagram illustrating the content of the semantic frames of the present invention according to one embodiment.

FIG. 9 is a diagram illustrating the parsing tree of the present invention according to another embodiment.

FIG. 10 is a diagram illustrating the semantic frames of the present invention according to another embodiment.

### DETAILED DESCRIPTION OF THE INVENTION

As summarized above, the present invention provides an apparatus of processing natural language speech data for receiving a natural language speech input in a handheld communication device and processing the natural language speech input to produce an output response. The natural language speech input is natural speech. The inventive apparatus comprises an automatic speech recognition unit, a natural language understanding unit, and an action and response unit installed in the handheld communication device.

The automatic speech recognition unit receives the natural language speech input, extracts and recognizes features of the natural language speech input, and produces an automatic speech recognition result. The automatic speech recognition unit includes a speech importer, a feature extractor, and a speech recognizer.

The speech importer is a user interface such as a microphone module for receiving natural language speech input. The feature extractor extracts the features of the natural language speech input. The speech recognizer refers to a language model database and an acoustic model database to recognize the features extracted by the feature extractor and produces the automatic speech recognition result.

The natural language understanding unit receives and analyzes the automatic speech recognition result, to produce a natural language understanding result. The natural language understanding unit comprises a grammar parser, a keyword analyzer, and a semantic frame manager.

The grammar parser receives the automatic recognition result and analyzes the grammar of the automatic recognition result referring to a grammar database. The keyword analyzer receives the automatic recognition result and analyzes keywords of the automatic recognition result. The semantic frame manager produces the natural language understanding result according to the analysis of the grammar parser and the keyword analyzer.

The action and response unit receives, and processes the natural language understanding result, to produce the output response. The action and response unit includes an information manager, a natural language generator, and a TTS (Text to Speech) composer.

The information manager receives the natural language understanding result and generates semantic frames corresponding to the natural language understanding result. The natural language generator generates natural language text according to the generated semantic frames. The TTS composer composes the natural language text into acoustic waveform and produces the output response.

The disclosed apparatus may comprise a wireless network interface, installed in the handheld communication device, communicating with a wireless network.

Furthermore, the invention discloses a method of processing natural language speech data input received by a handheld communication device to produce an output response. The natural language speech input comprises natural speech.

The handheld communication device first receives the natural language speech input, extracts and recognizes features of the natural language speech input, and produces an automatic speech recognition result. The detailed steps of producing the automatic recognition result are described as following. The handheld communication device receives the natural language speech input, extracts the features of the natural language speech input, and recognizes the extracted features to produce an automatic speech recognition result by referring to a language model database and an acoustic model database.

Next, the handheld communication device analyzes the automatic speech recognition result to produce a natural language understanding result. More specifically, the handheld communication device analyzes the grammar of the automatic recognition result by referring to a grammar database and analyzes keywords of the automatic recognition result, to produce the natural language understanding result according to the grammar and the keywords analysis.

Finally, the handheld communication device processes the natural language understanding result and produces the output response. Specifically, the handheld communication device generates semantic frames according to the natural language understanding result, generates natural language text based on the generated semantic frames, composes the natural language text into acoustic waveform, and produces the output response.

Moreover, the handheld communication device may communicate with a wireless network through a network interface installed in the handheld communication device.

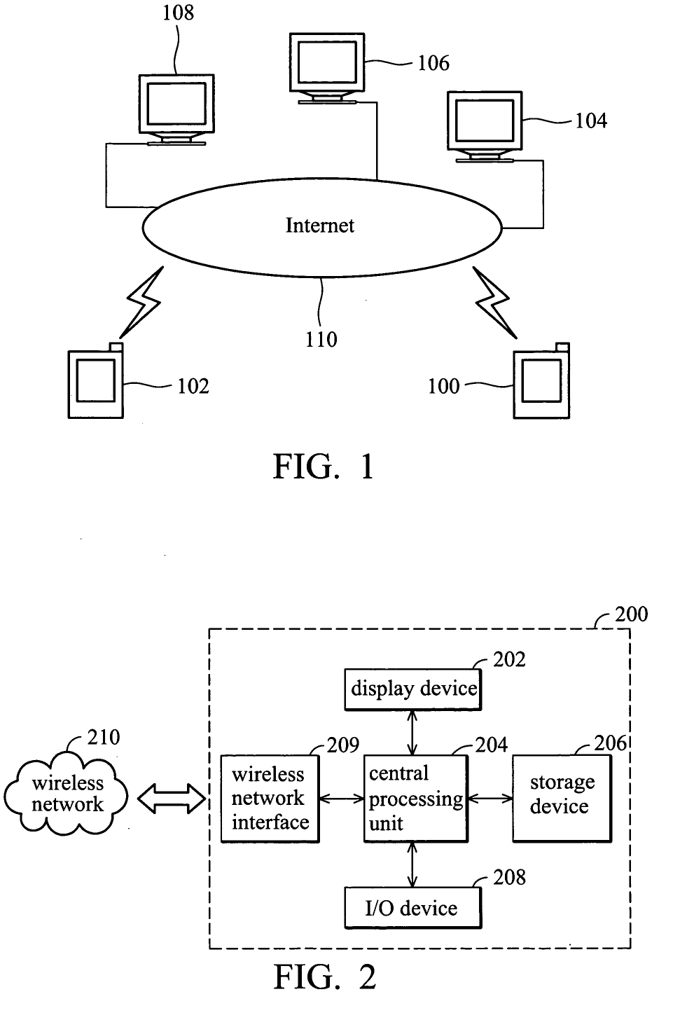

FIG. 1 is a diagram of the handheld communication device and the network according to the present invention. In FIG. 1, the handheld communication devices 100 and 102 enable wireless communication. The handheld communication devices 100 and 102 connect to the Internet 110 through a wireless network. Several Internet 110 servers, such as 104, 106, and 108, provide access to various functions and network resources. Thus, the handheld communication devices 100 and 102 can utilize different network resources or execute queries on servers 104, 106 and 108 through the wireless network.

FIG. 2 is a diagram of the handheld communication device according to the present invention. In one embodiment, a handheld communication device 200 communicates with a wireless network 210 through a wireless network interface 209. The handheld communication device 200 accesses wireless network 210 resources through the wireless network interface 209. The handheld communication device 200 includes a display device 202, a central processing unit 204, a storage device 206, and an I/O (input/output) device 208. The display device 202 displays text or selections. The central processing unit 204 processes speech data and controls the display device 202, storage device 206, and the I/O device 208. The storage device 206 stores the speech data or reference databases. If the reference database is remote database, the central processing unit 204 accesses the remote database through the wireless network 210. The I/O device 208 can be a user interface. Speech input is imported from the I/O device 208 and the handheld communication device 200 exports speech output through the I/O device 208.

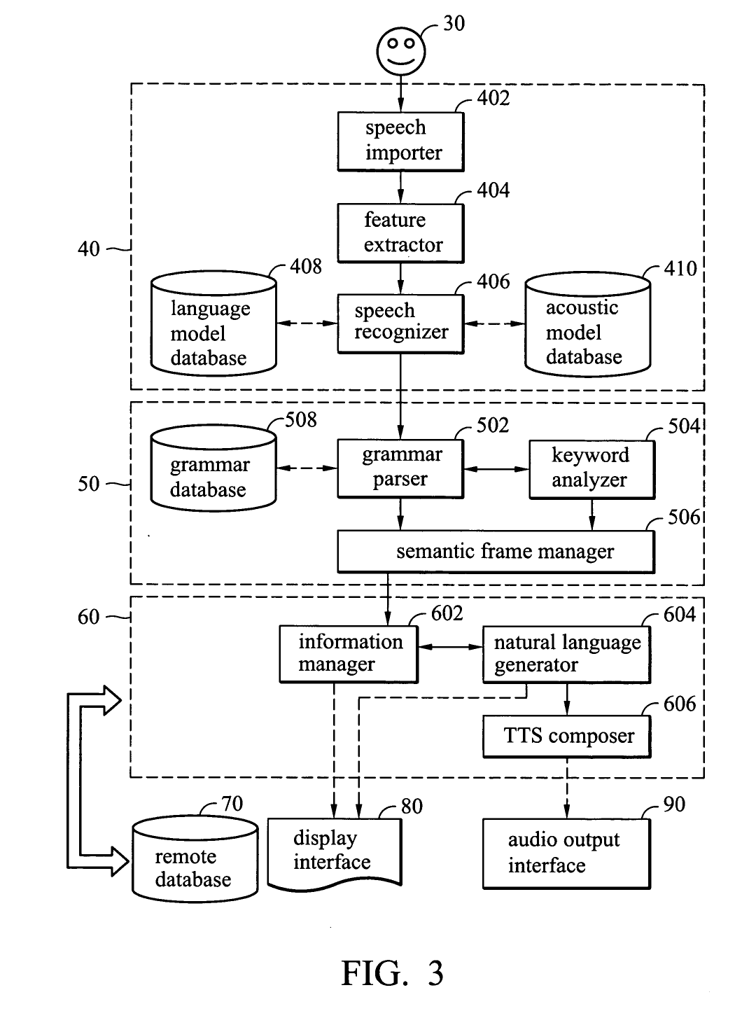

FIG. 3 is a diagram of an apparatus for processing natural language speech data according to the present invention. A natural language speech data processing apparatus is disclosed. The inventive apparatus receives a natural language speech input in a handheld communication device and processes the natural language speech input to an output response. The natural language speech input is the speech inputted by common users in natural language expressing way. In one embodiment, the inventive apparatus comprises an automatic speech recognition unit 40, a natural language understanding unit 50, and an action and response unit 60. The three units 40, 50, and 60 are installed in the handheld communication device.

The automatic speech recognition unit 40 receives natural language speech input 30, extracts and recognizes features of natural language speech input 30, and produces an automatic speech recognition result. The automatic speech recognition unit 40 includes a speech importer 402, a feature extractor 404, and a speech recognizer 406.

The speech importer 402 is a user interface for receiving the natural language speech input 30. The feature extractor 404 extracts the features of the natural language speech input 30. The speech recognizer 406 refers to a language model database 408 and an acoustic model database 410 to recognize the features extracted by the feature extractor 404. The speech recognizer 406 produces the automatic speech recognition result.

The natural language understanding unit 50 receives and analyzes the automatic speech recognition result, to produce a natural language understanding result. The natural language understanding unit 50 comprises a grammar parser 502, a keyword analyzer 504, and a semantic frame manager 506.

The grammar parser 502 receives the automatic recognition result and analyzes the grammar of the automatic recognition result referring to a grammar database 508. The keyword analyzer 504 receives the automatic recognition result and analyzes keywords of the automatic recognition result. The semantic frame manager 506 produces the natural language understanding result according to the grammar analysis of the grammar parser 502 and the keyword analysis of the keyword analyzer 504.

The action and response unit 60 receives and processes the natural language understanding result to produce the output response. The action and response unit 60 includes an information manager 602, a natural language generator 604, and a TTS composer 606.

The information manager 602 receives the natural language understanding result and generates semantic frames according to the natural language understanding result. The natural language generator 604 generates natural language text based on the generated semantic frames. The TTS composer 606 composes the natural language text into acoustic waveform and produces the output response.

The action and response unit 60 may connect to a remote database 70, a display interface 80, and an audio output interface 90. During data processing, if the information manager 602 determines that the semantic frames are queries on remote database 70, the information manager 602 accesses the remote database 70.

If the semantic frames are determined by the information manager 602 to be text or figures, then the semantic frames are displayed by the display interface 80. If the semantic frames generated by the information manager 602 require conversion to acoustic wave output, the generated semantic frames are sent to the natural language generator 604 to produce natural language text. The natural language text is then sent to the TTS composer 606 to compose the acoustic waveform and the output response. The TTS composer 606 outputs the produced acoustic waveform and the output response through the audio output interface 90. The natural language text generated by the natural language generator 604 can be also expressed in text and output by the display interface 80 directly.

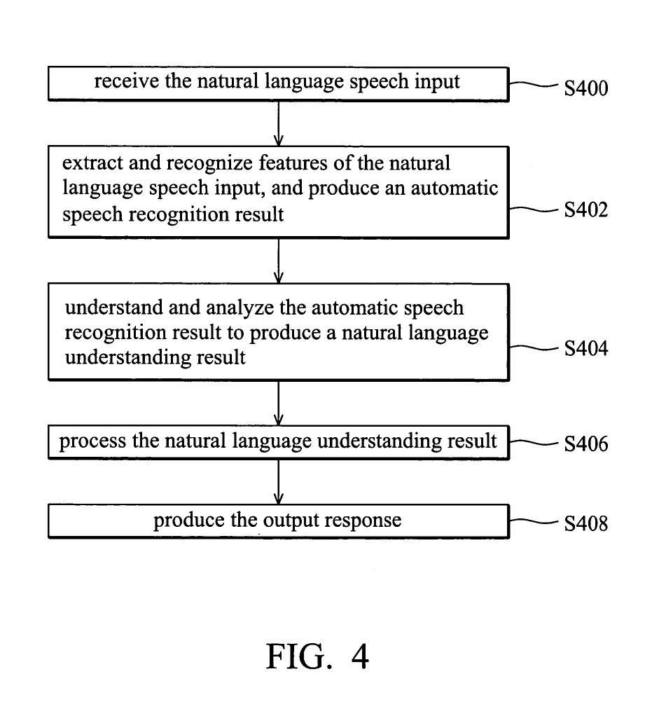

FIG. 4 is a flowchart of the method of processing natural language speech data according to the present invention. The invention provides a method of processing natural language speech data for receiving natural language speech input by a handheld communication device and processing the natural language speech input to an output response. Here, the natural language speech input, comprises natural speech.

The handheld communication device first receives the natural language speech input (step S400), extracts and recognizes features of the natural language speech input, and produces an automatic speech recognition result (step S402). The production step S402 includes the following steps. The handheld communication device receives the natural language speech input, extracts the features of the natural language speech input, recognizes the extracted features referring to a language model database and an acoustic model database, and produces the automatic speech recognition result.

Next, the handheld communication device understands and analyzes the automatic speech recognition result to produce a natural language understanding result (step S404). More specifically, the handheld communication device analyzes the grammar of the automatic recognition result by referring to a grammar database and analyzes keywords of the automatic recognition result, to produce the natural language understanding result according to analysis of the automatic recognition result.

Finally, the handheld communication device processes the natural language understanding result (step S406) and produces the output response (step S408). In detail, the handheld communication device generates semantic frames according to the natural language understanding result, generates natural language text according to the generated semantic frames, and converts the natural language text into acoustic waveform and the output response.

Referring to the diagram shown in FIG. 3, if the natural language speech input 30 is “Remind me to go to the airport next Monday,” then the speech importer 402, such as a microphone, receives the natural language speech input 30. The natural language speech input 30 will then be converted into digital samples. The digital samples compose frames. The composed frames are processed by the feature extractor 404 to extract the features of each frame. The speech recognizer 406 then refers to a language model database 408 and an acoustic model database 410 for recognition of features extracted by the feature extractor 404 producing the automatic speech recognition result, i.e. the most probable meaning of the natural language speech input.

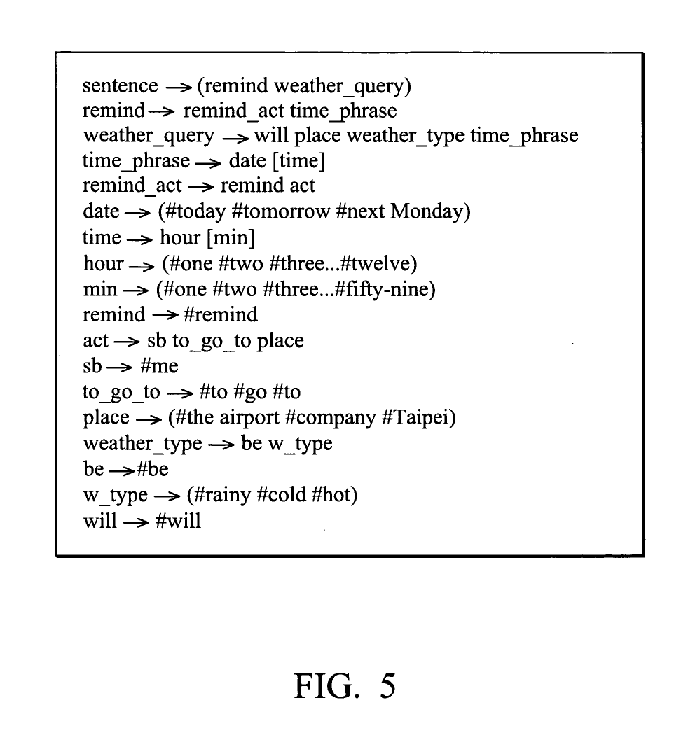

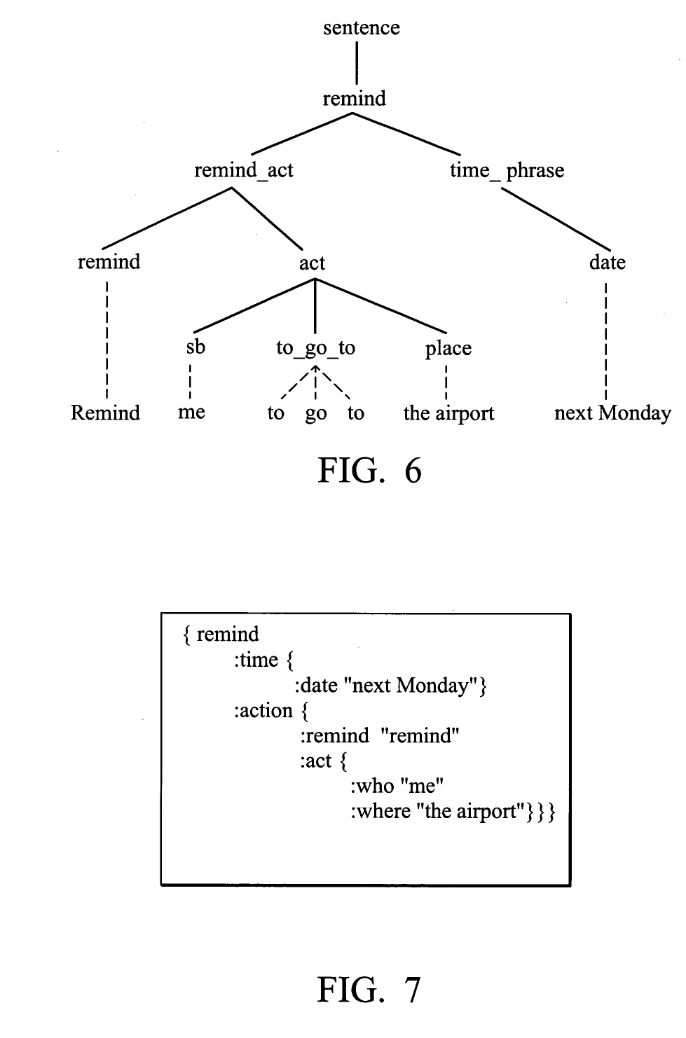

The automatic speech recognition result is then sent to the natural language understanding unit 50 for analysis. The grammar parser 502 first receives and analyzes the automatic recognition result referring to a grammar database 508. The grammar stored in the grammar database 508 can be pre-determined, as shown in FIG. 5. FIG. 5 is a diagram illustrating the grammar of the present invention according to one embodiment. The grammar parser 502 parses the automatic recognition result into a structured parsing tree, as shown in FIG. 6. FIG. 6 is a diagram illustrating the parsing tree of the present invention according to one embodiment. If the grammar parser 502 is able to parse the automatic recognition result into a structured parsing tree successfully, then the semantic frame manager 506 produce semantic frames according to the structured parsing tree. Conversely, if the grammar parser 502 is unable to parse the automatic recognition result into a structured parsing tree, then the keyword analyzer 504 analyzes keywords of the automatic recognition result. The semantic frame manager 506 then composes the keywords analyzed by the keyword analyzer 504 into semantic frames. The semantic frames are the natural language understanding result produced by the natural language understanding unit 50.

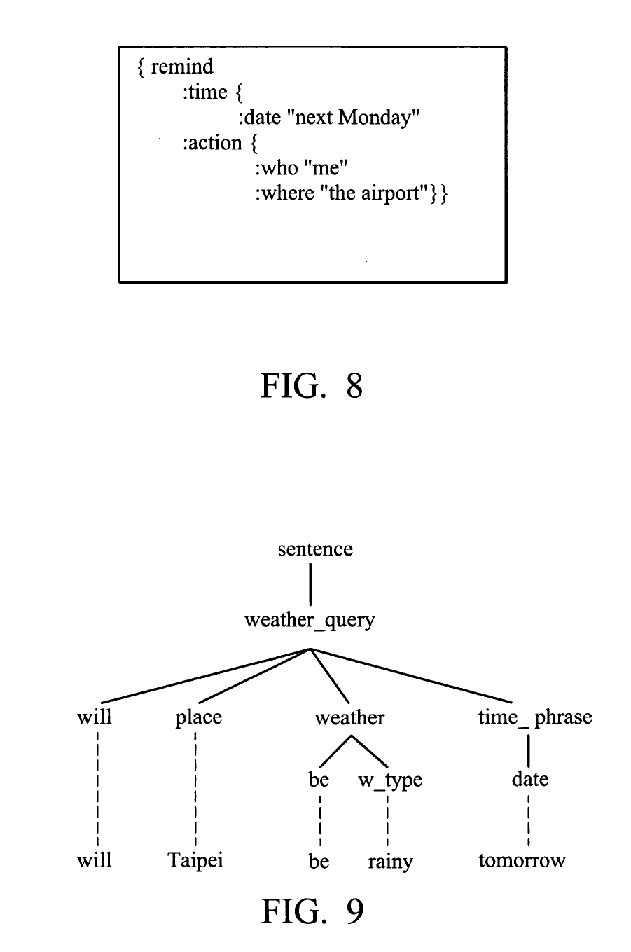

The natural language understanding result will be sent to the action and response unit 60. First, the information manager 602 receives the natural language understanding result and generates the semantic frames according to the natural language understanding result. The information manager 602 recognizes the natural language understanding result as “Remind,” as shown in FIG. 7. FIG. 7 is a diagram illustrating the semantic frames of the present invention according to one embodiment. The information manager 602 then records the time and content of “Remind”, as illustrated in FIG. 8. FIG. 8 is a diagram illustrating the content of the semantic frames of the present invention according to one embodiment. Thus, the information manager 602 displays a reminder at a designated time on the display interface 80. The information manager 602 can also send the remind content to the natural language generator 604 and the TTS composer 606 to produce the output response. The output response may be “I will go to the airport tonight.” The output response can be output through the audio output interface 90.

If “Will Taipei be rainy tomorrow?” is the natural language speech input 30, it is converted into digital samples. A pre-determined number of digital samples compose a frame. The composed frames are processed by the feature extractor 404 to extract the features of each frame. The speech recognizer 406 then refers to a language model database 408 and an acoustic model database 410 to recognize the features extracted by the feature extractor 404. The speech recognizer 406 determines the most probable meanings of the sentences to be the automatic speech recognition result.

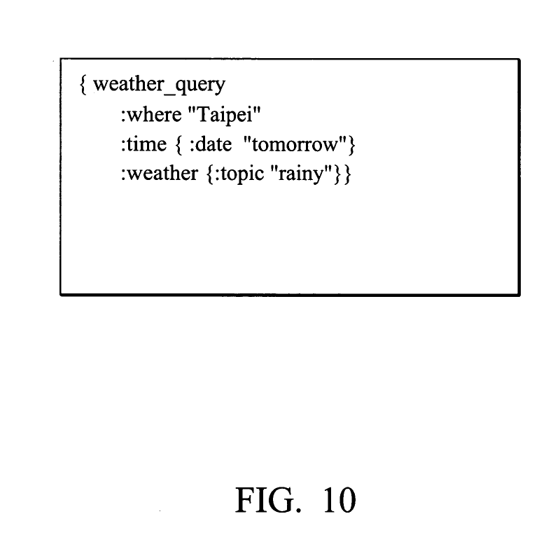

The automatic speech recognition result is then sent to the natural language understanding unit 50 for understanding and analyzing. The grammar parser 502 first analyzes the automatic recognition result referring to a grammar database 508. The grammar parser 502 parses the automatic recognition result into a structured parsing tree, as shown in FIG. 9. FIG. 9 is a diagram illustrating the parsing tree of the present invention according to another embodiment. The semantic frame manager 506 then composes the structured parsing tree into semantic frames, i.e. the natural language understanding result, as shown in FIG. 10. FIG. 10 is a diagram illustrating the semantic frames of the present invention according to another embodiment.

The natural language understanding result will be sent to the action and response unit 60. The information manager 602 first receives the natural language understanding result and generates corresponding semantic frames. The information manager 602 then determines that the natural language understanding result is “Query.” The information manager 602 then executes a query on the remote database 70, such as a SQL query, according to the query content as shown in FIG. 10. The query result can be displayed in text through the display interface 80. The query result can also be sent to the natural language generator 604 and the TTS composer 606 to compose the output response. The output response, which may be a weather forecast, for example, is then output through the audio output interface 90.

Thus, the apparatus provided by the present invention can receive and process natural language speech input and produce an output response, achieving the objects of the invention. Particularly, the integration of the natural language speech data processing capability in a single handheld communication device solves the present problems of speech data processing and enhances related technology.

It will be appreciated from the foregoing description that the apparatus and method described herein provide a dynamic and robust solution to natural language speech data processing problems. If, for example, the language input to the device changes, the apparatus and method of the present invention can be revised accordingly by adjusting the reference databases.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for receiving and processing natural language speech data input in a handheld communication device and processing the natural language speech input to produce an output response, comprising:
an automatic speech recognition unit, installed in the handheld communication device, receiving the natural language speech input, extracting and recognizing features of the natural language speech input, and producing an automatic speech recognition result;
a natural language understanding unit, installed in the handheld communication device and coupled to the automatic speech recognition unit, receiving, understanding, and analyzing the automatic speech recognition result, and producing a natural language understanding result; and
an action and response unit installed in the handheld communication device and coupled to the natural language understanding unit, receiving and processing the natural language understanding result, and producing the output response.

2. The apparatus as claimed in claim 1, further comprising a wireless network interface, installed in the handheld communication device, communicating with a wireless network.

3. The apparatus as claimed in claim 1, wherein the automatic speech recognition unit further comprises:
a speech importer, receiving the natural language speech input from a user interface;
a feature extractor, coupled to the speech importer, extracting the features of the natural language speech input; and
a speech recognizer, coupled to the feature extractor, recognizing the features extracted by the feature extractor and producing the automatic speech recognition result.

4. The apparatus as claimed in claim 3, wherein the speech recognizer refers to a language model database and an acoustic model database to recognize the extracted features.

5. The apparatus as claimed in claim 1, wherein the natural language understanding unit further comprises:
a grammar parser, receiving the automatic recognition result and analyzing grammar accordingly;
a keyword analyzer, coupled to the grammar parser, receiving the automatic recognition result and analyzing keywords accordingly; and
a semantic frame manager, coupled to the grammar parser and the keyword analyzer, producing the natural language understanding result according to the analysis of the grammar parser and the keyword analyzer.

6. The apparatus as claimed in claim 5, wherein the grammar parser refers to a grammar database to analyze the grammar of the automatic recognition result.

7. The apparatus as claimed in claim 1, wherein the action and response unit comprises:
an information manager, receiving the natural language understanding result and generating semantic frames accordingly;
a natural language generator, coupled to the information manager, generating natural language text according to the generated semantic frames; and
a TTS composer, coupled to the natural language generator, composing the natural language text into acoustic waveform and producing the output response.

8. The apparatus as claimed in claim 1, wherein the natural language speech input comprises natural speech.

9. A method of processing natural language speech data for receiving natural language speech input in a handheld communication device and processing the natural language speech input to an output response, comprising the steps of:
the handheld communication device receiving the natural language speech input, extracting and recognizing features of the natural language speech input, and producing an automatic speech recognition result;
the handheld communication device understanding, analyzing the automatic speech recognition result, and producing a natural language understanding result; and
the handheld communication device processing the natural language understanding result and producing the output response.

10. The method as claimed in claim 9, the handheld communication device further communicating with a wireless network through a wireless network interface, wherein the wireless network interface is installed in the handheld communication device.

11. The method as claimed in claim 9, wherein the step of producing the automatic recognition result further comprises the steps of:
receiving the natural language speech input;
extracting the features of the natural language speech input; and
recognizing the extracted features and producing the automatic speech recognition result.

12. The method as claimed in claim 11, wherein the recognition of the extracted features refers to a language model database and an acoustic model database.

13. The method as claimed in claim 9, wherein the step of producing the natural language understanding result further comprises the steps of:
analyzing grammar of the automatic recognition result;
analyzing keywords of the automatic recognition result; and
producing the natural language understanding result according to the analysis of the grammar and keywords of the automatic recognition result.

14. The method as claimed in claim 13, wherein the grammar analysis of the automatic recognition result refers to a grammar database.

15. The method as claimed in claim 9, wherein the step of producing the output response further comprises:
generating semantic frames according to the natural language understanding result;
generating natural language text according to the generated semantic frames; and
composing the natural language text into acoustic waves and producing the output response.

16. The method as claimed in claim 9, wherein the natural language speech input comprises natural speech.
